(19) United States
(12) Patent Application Publication
(10) Pub. No.: US 2008/0208844 A1
(43) Pub. Date: Aug. 28, 2008

(54) ENTERTAINMENT PLATFORM WITH LAYERED ADVANCED SEARCH AND PROFILING TECHNOLOGY

(76) Inventor: Michael D. Jenkins, New London, TX (US)

Correspondence Address: FISH & RICHARDSON P.C., P.O. BOX 1022, MINNEAPOLIS, MN, 55440-1022, US

(21) Appl. No.: 12/037,763

(22) Filed: Feb. 26, 2008

Related U.S. Application Data
(60) Provisional application No. 60/903,740, filed on Feb. 27, 2007.

(51) Int. Cl. G06F 17/30

(52) U.S. Cl. 707/5; 707/E17.108

(57) ABSTRACT

This disclosure provides various implementations for locating industry profiles representing members of an entertainment platform community. The software can query a plurality of industry profiles with a first set of search criteria associated with a target member of the entertainment platform community and generate a first cache of industry profiles based on the first set of search criteria, the first cache a subset of the plurality of industry profiles. Further, the software can query the first cache with a second set of search criteria, wherein the second set of criteria are mutually exclusive from the first set of criteria, and generate a second cache of industry profiles based on the second set of search criteria, the second cache a subset of the first cache of industry profiles. The software can then present information from at least one industry profile represented in the second cache to an interface.

### CLAIM OF PRIORITY

This application claims priority under 35 USC § 119(e) to U.S. Patent Application Ser. No. 60/903,740, filed on Feb. 27, 2007, the entire contents of which are hereby incorporated by reference.

### TECHNICAL FIELD

This disclosure relates to data processing and, more particularly, to searching and profiling a plurality of industry profiles associated with an entertainment platform.

### BACKGROUND

Social networking has increased in popularity in recent years because of the emergence of web sites such as MySpace and Facebook. In general, social networks build on- and off-line communities of people who share interests and activities, or who are interested in exploring the interests and activities of others. Social networks effectively allow users to create individualized accounts describing themselves through a series of categories, disclosures, questions, and various media (e.g., audio, video, and/or graphic) relating to the user, such as the user's personal preferences and social demographics. Additionally, social networks provide various features for user interaction, including chat, messaging, email, video, file sharing, blogging, groups, and more. Using these features, users are able to integrate themselves into the social network, creating a network of friends and associates linked through the various interests and activities of the community.

Social networks offer community-building not only for individuals, but also for professionals and businesses. For instance, entrepreneurs and small businesses may use social networks to broaden their contact list and further their geographic boundaries. Because many social networking services are web-based, the physical location of the individuals or businesses present less of a barrier than in real-world relationships. However, as social networks continue to grow, the size and nature of the networks make locating individuals or businesses fitting a set of desired criteria difficult. For instance, robust searching within current social networks is unavailable—or at best, primitive—as the current search methods provide limited depth and functionality. Without more robust search mechanisms, attempting to pinpoint user profiles meeting clearly defined criteria is difficult and time-consuming.

### SUMMARY

This disclosure provides various implementations for locating industry profiles representing members of an entertainment platform community. The software can query a plurality of industry profiles with a first set of industry profile search criteria associated with one or more target members of the entertainment platform community and generate a first cache of industry profiles based on the first set of industry profile search criteria, wherein the first cache is a subset of the plurality of industry profiles. Further, the software can query the first cache with a second set of industry profile search criteria, wherein the second set of industry profile search criteria is mutually exclusive from the first set of industry profile criteria, and generate a second cache of industry profiles based on the second set of industry profile search criteria, wherein the second cache of industry profiles is a subset of the first cache of industry profiles. The software can then present information from at least one industry profile represented in the second cache of industry profiles to an interface. In some instances, software can extrapolate a set of data associated with the at least one industry profiles for presentation to the interface.

While generally described as software, some or all of these aspects may be further included in respective systems or other devices for executing, implementing, or searching for industry profiles in an entertainment platform. The details of these and other aspects and implementations of the disclosure are set fort in the accompanying drawings and the description below. Other features, objects, and advantages of the present disclosure will be apparent from the description and drawings, and from the claims.

### DESCRIPTION OF DRAWINGS

FIG. 1 illustrates a software environment that allows for searching a plurality of industry profiles associated with an entertainment platform according to a particular implementation of the present disclosure;

FIG. 2 is a flowchart illustrating one example of the steps for performing a layered search on a plurality of industry profiles according to a particular implementation of the present disclosure;

FIG. 3 is a flowchart illustrating another perspective of the steps for performing a layered search on a plurality of industry profiles according to a particular implementation of the present disclosure;

FIG. 4 is a flowchart illustrating an example of the steps for integrating additional sets of associated external information into an industry profile according to a particular implementation of the present disclosure;

FIG. 5 is a flowchart illustrating an example of the steps for creating an industry profile according to a particular implementation of the present disclosure;

FIG. 6 illustrates one embodiment of a visual interface viewable at the client via a GUI for an industry profile search template presenting an initial industry profile search within the illustrated environment of FIG. 1;

FIG. 7 illustrates one embodiment of the visual interface viewable at the client via the GUI for a search results interface presenting the results of an industry profile search within the illustrated environment of FIG. 1;

FIG. 8 illustrates one embodiment of the visual interface viewable at the client via the GUI for a layered industry profile search template allowing for layered searching on a previously returned set of responsive industry profiles within the illustrated environment of FIG. 1;

FIG. 9 illustrates one embodiment of the visual interface viewable at the client via the GUI for displaying a generic industry profile within the illustrated environment of FIG. 1; and

FIG. 10 illustrates one embodiment of the visual interface viewable at the client via the GUI for selecting a specific industry profile search type within the illustrated environment of FIG. 1.

### DETAILED DESCRIPTION

The present disclosure provides a system combining the popularity and community of a social network with an interactive music industry exchange. An entertainment platform as detailed herein provides individuals and professionals within the entertainment industry, including, for example, artists, artist management, songwriters, publishers, record labels, talent buyers, consumers, and music fans, an opportunity to join and participate in an integrated online social and business community for sharing and promoting music and music-related services within the music industry, as well as providing members with additional exposure to potential business partners, consumers, and fans. The entertainment platform creates an integrated and intertwined network of micro-sites, portals, and profiles providing maximum revenue output for members and users. The entertainment platform allows its members to design their own detailed and customizable industry profiles that can include, for instance, biographical and professional information, audio, video, and other media files, and the members' audience demographics (e.g., the types of consumers or fans associated with the member), as well as other information relevant to the members and the music industry.

In particular implementations, the entertainment platform provides advanced search capabilities allowing members and users of the entertainment platform to create richly detailed profiles of a target or desired industry professional or member of the entertainment platform community. Based on the profile, the system searches for and returns, to the member or user, a set of industry profiles matching the specified set of criteria associated with the target profile. For example, profile-based searches may be utilized by artists searching for a potential record label, songwriters searching for a possible collaborating artist, artist management representatives searching for a potential artist or songwriter to manage, or consumers and music fans searching for new artists in a specific genre or geographical location, as well as other relevant types of searches that will be understood from the present application. If the initial profile fails to return a manageable number of results, additional layers of search criteria may be added to the previous search. By caching each set of returned search results, the system allows for advanced layer-by-layer searches of responsive industry profiles, with each advancing layer of searching becoming more and more specific, narrowing each cached set of search results until a manageable number of industry profiles are located. The criteria provided to find a target member of the entertainment platform community may be a preliminary or pre-search definition of the desired industry profile. However, the target member may change during the course of a search, either through alterations to the requirements for a target profile, or based on trends found as additional layers of search results are returned. Further, while the actual members returned by the search may satisfy the target member criteria, one or more of the actual members located may not be an exact or appropriate match for the search. For instance, the actual members returned by the target member criteria may match the set of criteria provided, but may not be available to enter into the particular business relationship envisioned by the searching member or user. This may occur if the actual located member is not available at the times needed or desired by the searching member or user, the actual located member charges a higher price than specified in the actual member's industry profile, or an entity represented by the searching member or user rejects the actual located member for reasons other than the target member search criteria. The entertainment platform provides distinct advantages to artists and songwriters with limited marketing visibility or promotional budgets by providing multi-directional flows of data for increased market exposure to both industry professionals and potential consumers and fans, specifically as compared to other social networking profiles. Further, the entertainment platform allows record labels, talent buyers, and artist managers to quickly and efficiently identify, locate, and contact unsigned or unrealized talent from anywhere in the world through a convenient centralized interface.

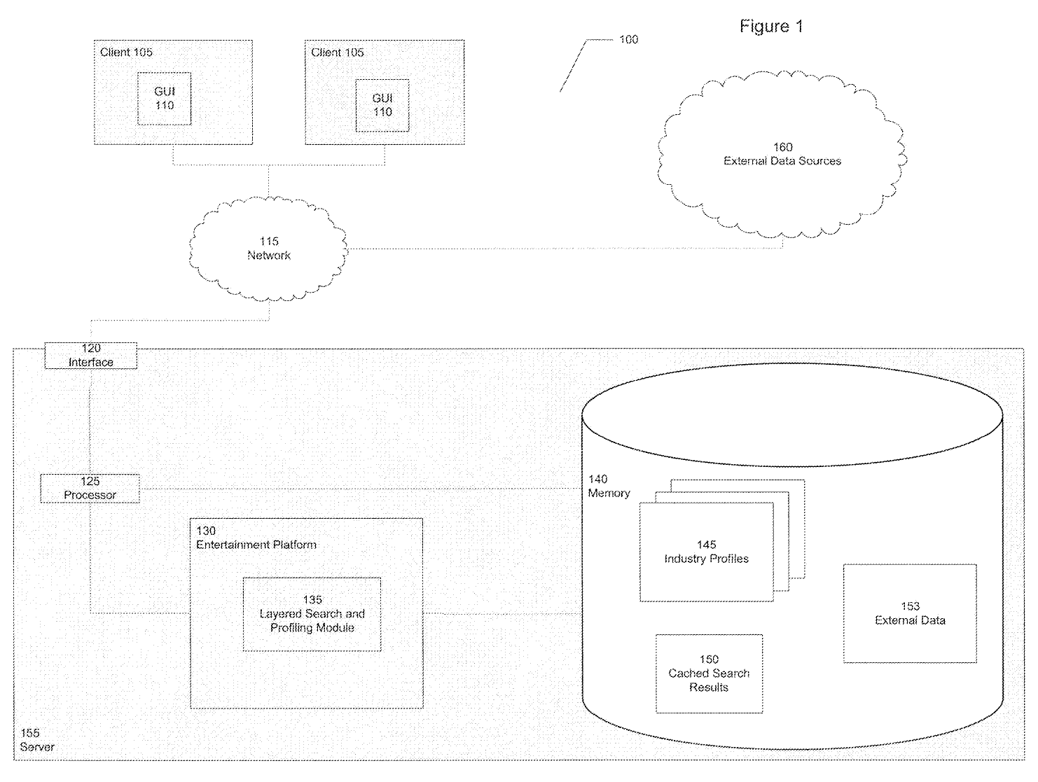

FIG. 1 illustrates an environment 100 for the implementation of layered advanced search and profiling functionality in an entertainment platform 130. In accordance with particular implementations, illustrated environment 100 includes the entertainment platform 130 and layered search and profiling module 135 (running within a server 155) allowing in-depth layered searching and profiling of a plurality of industry profiles 145 associated with one or more members and/or users of the entertainment platform 130. The industry profiles 145 comprise customized profiles including personal and business information associated with one or more members and users of the entertainment platform 130. The entertainment platform 130 and the layered search and profiling module 135 may provide layered advanced searches allowing a client 105 to quickly locate one or more industry profiles 145 that match a set of search criteria identified and submitted by the client 105. Searches may be based on any number of criteria associated with various industry profiles 145, including media content and business information included within or associated with a particular industry profile 145, as well as other information derived from other member or user profiles linked to the particular industry profile 145 through direct or indirect relationships created in the entertainment platform 130. Further, the layered search and profiling module 135 may allow members or users to evaluate industry profiles 145 in advancing layer pools, for instance, by providing additional narrowing (or layered) search criteria to one or more sets of industry profiles returned from previous searches, continuing until a manageable or desired quantity of industry profiles 145 is identified. The layered searches of the plurality of industry profiles 145 allows members or users of the entertainment platform 130 to easily and more efficiently locate a set of industry profiles 145 matching a specific desired set of criteria.

Turning to the example implementation of FIG. 1, environment 100 includes, or is communicably coupled with, the server 155, one or more clients 105, a network 115, and one or more external data sources 160. The server 155 may include a memory 140, as well as one or more processors 125, and comprise an electronic computing device operable to receive, transmit, process, store, or manage data associated with the environment 100. Generally, this disclosure provides merely one example of computers that may be used with the disclosure. As used in this document, the term “computer” is intended to encompass any suitable processing device. For example, the environment 100 may be implemented using computers other than servers, as well as a server pool. Indeed, the server 155 may be adapted to execute any operating system including Linux, UNIX, Windows, or any other suitable operating system. According to one implementation, the server 155 may also include or be communicably coupled with a web server and/or a mail server.

Memory 140 may include any memory or database module and may take the form of volatile or non-volatile memory including, without limitation, magnetic media, optical media, random access memory (RAM), read-only memory (ROM), removable media, or any other suitable local or remote memory component. For example, memory 140 may store classes, frameworks, applications, backup data, business objects, jobs, industry profiles, external data, various types of media (e.g., video, audio, or graphic), or other information that includes any parameters, variables, algorithms, instructions, rules, constraints, or references thereto. The memory 140 may also include any other appropriate data, such as virtual private network (VPN) applications, firmware logs and policies, firewall policies, a security or access log, print or other reporting files, HTML files or templates, and others.

Specifically, illustrated memory 140 includes a plurality of industry profiles 145 associated with the entertainment platform 130. While illustrated within memory 140 of FIG. 1, one or more of the plurality of industry profiles 145 may be located outside memory 140 and/or the server 155 in some implementations. Additionally, the plurality of industry profiles 145 may initially be empty, full of templates, or have just one industry profile. Each industry profile 145 represents information and/or media associated with a member or user of the entertainment platform 130. When members or users register with or join the entertainment platform 130, an industry profile template may be presented to the member or user providing a questionnaire, inventory, or set of information requests that allow the member or user to submit personal and/or business information and media to the entertainment platform 130, the information and media relating to their work, themselves, their businesses, or their professional status. In the present embodiment, members and users of the entertainment platform 130 may include, for example, artists or musicians, songwriters, record label representatives, artist management representatives, talent buyer representatives, and music fans or consumers, as well as other individuals or entities. Alternative embodiments may include other types of members and users. In one embodiment, an artist registering with the entertainment platform 130 can submit personal information such as his or her name, gender, age, and geographic location, among other data. Further, the artist can also submit additional information regarding his or her musical abilities, professional experience, and music affiliations. For example, the information provided may include the artist's genre(s) of music (i.e., country, R&B or soul, pop, rock, rap or hip-hop, jazz, classical, instrumental, inspirational or gospel, alternative, children's, international, Latino, dance or electronica, tribute artist, etc.), whether the artist is a songwriter, whether the artist has a songwriter organization membership, whether the artist is under management, whether the artist has live performance or recording experience, whether the artist is signed to a recording contract, how the artist's work is distributed (i.e., internet, retail store, or both), what type of artist or performer the artist is (i.e., solo, duet, or group), whether the artist has been listed on a radio chart (i.e., major chart, indie chart, etc.), and the price for a live music performance by the artist, among others. In some embodiments, the artist may be able to submit audio and video samples or full-recordings of performances or tracks to the entertainment platform 130 for association with his or her industry profile 145. Further, the artist may be able to embed the audio and video media into the industry profile 145 for viewing by other members or users. Members and users browsing the industry profile 145 may be able to view or listen to the embedded media without executing an additional external program. Still further, the artist may be able to submit graphics for display with the industry profile, including logos, photos from performances, artist headshots or professional images, and other graphics or images. The artist, or any member or user creating an industry profile 145, may further customize his or her industry profile using predefined templates, original artwork, and other suitable design techniques and tools. In some instances, third party designed templates may be associated with the industry profile 145 allowing for a more personalized and unique industry profile 145. The submitted information comprising each industry profile 145 may be stored in memory 140 as an XML file, a database file, a data file, a flat file, a comma-delimited file, media files such as audio or video media files, another appropriate storage type, or a combination thereof.

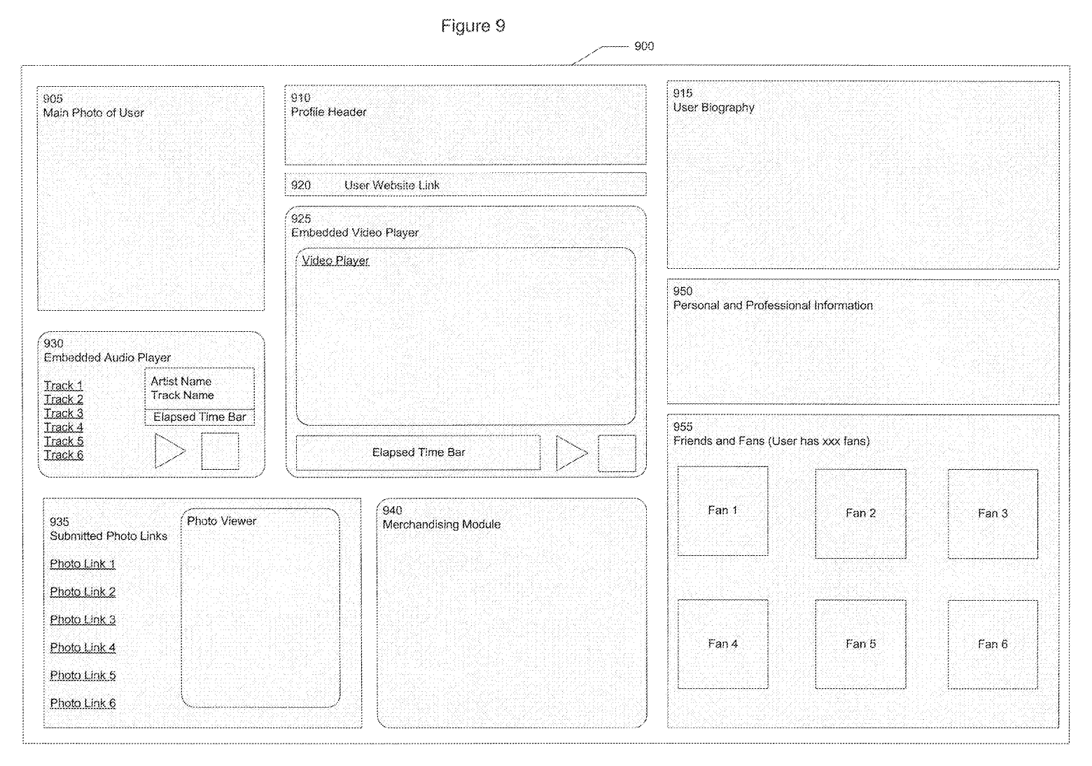

FIG. 9 illustrates one embodiment of a generic industry profile 900 as viewed by a member or user of the entertainment platform 130 browsing the plurality of industry profiles 145 on a GUI 110 at client 105. In some instances, at least a portion of the information displayed is provided by the member or user and associated with the industry profile 900 at the profile's creation. In addition, the member or user associated with the generic industry profile 900 may review, edit, and update the information included within the industry profile 900 at any time. As illustrated, the generic industry profile 900 comprises a primary profile photo 905, a profile header 910, a profile biography 915, a user website link 920, an embedded video player 925 for presenting video samples or performances associated with the profile 900, an embedded audio player 930 for presenting audio samples or performances associated with the profile 900, a photo viewer 935 for presenting photos and/or graphics associated with the profile 900, a merchandising module 940 linked to a media store portal included in the entertainment platform 130 or an external media store, a personal and professional information section 950, and a friends and fans section 955 including links to profiles of other industry members, consumers, or users associated with the generic industry profile 900. In some embodiments, the friends and fan section 955 may display a set of metrics calculated using information from one or more industry profiles, as well as consumer or fan profiles associated with the social network portal, as well as one or more industry profiles associated with other industry members or users linked with the generic industry profile 900, such as fans and friends of the member or user. For instance, the set of information in the friends and fan section 955 may include a chart, graph, or table displaying one or more calculated metrics based on the demographic information related to the artist's friends and fans linked to the artist's industry profile 145 through the entertainment platform 130. In some instances, additional information associated with friends, fans, or the member or user himself may be retrieved from one or more external data sources 160 (shown in FIG. 1), allowing the member or user to leverage previous work, relationships, and marketing associated with other established social networks including other user profiles and relationships, as well as other relevant sets of data or information linked to the industry profile 900, but located in an external environment. In some implementations, members or users may be able to organize the layout of the industry profile 900 using predefined profile templates, enhanced drag-and-drop design functionality, third party templates, or any other appropriate layout editor or template.

In alternative implementations, each industry profile 900 may comprise multiple pages of content associated with the member or user, wherein one or more of the pages of content provide additional functionality within the entertainment platform 130. For instance, one implementation of the industry profile 900 associated with an artist may include one or more of the following pages: an artist biography page, a radio chart history page for the artist, an artist booking page allowing other industry professionals to engage the artist in a business relationship (i.e., booking the artist for an event, signing the artist to a record contract or management agreement, etc.), a consumer or fan rating page providing functionality for consumers and fans to rate and comment upon the artist, an eCommerce page for the artist to market and sell his or her music and merchandise, a social network community page for display and use with the social network portal of the entertainment platform 130, a fan club page allowing consumers to join the artist's fan club, an industry rating page allowing other industry professionals to rate or comment upon the artist, a live performance review and reference page, a public relations page for the artist, and a press package page including visual, audio, video media for use in marketing and sales associated with the artist. Other appropriate information may also be included within each industry profile 900.

Returning to FIG. 1, the memory 140 also includes a set of cached search results 150. The set of cached search results 150 stores search results returned from queries directed to the plurality of industry profiles 145. At varying times, the set of cached search results 150 may be empty, contain a single cached industry profile, or store a plurality of cached industry profiles returned in previous searches. For instance, an initial industry profile search from the client 105 for “an unsigned Country/Western artist in North Texas” may return 50 results. In addition to providing the set of results to the requesting client 105, the results may also be stored in the set of cached search results 150. As additional sets of limiting or layered criteria are received providing for more detailed searches that narrow the results of previous, broader searches (e.g., criteria limiting the example search results to “an unsigned Country/Western artist in North Texas between 20 and 25 years old”), the queries associated with the additional detailed searches access the set of cached search results 150 instead of the plurality of industry profiles 145. By searching the set of cached search results 150, rather than the plurality of industry profiles 145, quicker and more efficient searches can be performed by avoiding duplicative searching within the generally larger set of the plurality of industry profiles 145 by focusing the additional searches on the generally smaller set of cached search results 150. In some instances, the cached search results 150 may be stored in a similar format as the information in the plurality of industry profiles 145, such as XML files, database files, data files, flat files, comma-delimited files, or any other appropriate file type or combination of files types. In other instances, the set of cached search results 150 may be a reference file providing links to one or more industry profiles 145 within the plurality of industry profiles 145 returned from previous industry profile searches. In still other instances, the set of cached search results 150 may be stored as a new or temporary table within the database storing the plurality of industry profiles 145, as well as any other appropriate storage type. As additional layers of searches are performed, either on the initial set of industry profiles returned after the initial industry profile search, or on later sets of responsive industry profiles 145 returned from layered searches, the set of cached search results 150 may overwrite, delete, or remove previous industry profiles 145 or references thereto previously stored within the sets of cached search results 150 that no longer meet the narrowed set of search criteria specified in the newest query. Thus, each successive industry profile search may result in quicker results and returns as fewer industry profiles 145 are queried for matching criteria in each advancing layer of the search.

Memory 140 may also include a set of collected external data 153 associated with one or more of the plurality of industry profiles 145. The set of external data 153 may include audio or video files associated with a particular industry profile 145 that were previously stored or located at another website or social network. The set of external data 153 may also contain profiles, information extracted from profiles, or other information associated with a particular industry profile 145 retrieved from the one or more external data sources 160. For instance, information on friends and fans associated with the particular industry profile 145 may be retrieved from one or more external data sources 160 and stored in the set of external data 153 within memory 140. Still further, the external data 153 may include sales data or radio chart information retrieved from external vendors or informational databases. Alternative implementations may retrieve other types of external data than those described herein. In some instances, metrics and other information can then be derived or calculated from the external data 153. Those metrics or resulting values, as well as other information or data, can then be added into the particular associated industry profile 145 to seamlessly integrate a wide-variety of data and other information available outside of the entertainment platform 130. The set of external data 153 can store the data in any appropriate format. In some instances, the set of external data 153 may be stored as references to the original files located at the one or more external data sources in order to minimize the storage requirements of memory 140. In other instances, the set of external data 153 may be stored remotely from memory 140.

Illustrated server 155 also includes a processor 125. The processor 125 executes instructions and manipulates data to perform the operations of the server 155 such as, for example, a central processing unit (CPU), a blade, an application specific integrated circuit (ASIC), or a field-programmable gate array (FPGA). Although described as a single processor in the server 155, multiple processors 125 may be used according to particular needs and references to processor 125 are meant to include multiple processors where applicable. In certain embodiments, including the particular embodiment of FIG. 1, the processor 125 executes the entertainment platform 130, which is any software operable to invoke or execute certain described processes such as the layered search and profiling module 135. Regardless of the particular implementation, “software” may include software, firmware, wired or programmed hardware, or any combination thereof as appropriate. Indeed, the entertainment platform 130 may be written or described in any appropriate computer language including but not limited to C, C++, Java, Visual Basic, assembler, Perl, AJAX, Adobe Flash, any suitable version of 4GL, a proprietary computer language, among others. It will be understood that the entertainment platform 130 may include any number of sub-modules, such as a business application and various modules, but it may instead be a single multi-tasked module that implements the various features and functionality through various objects, methods, or other processes. Further, while described as internal to the server, one or more processes associated with the entertainment platform 130 may be stored, referenced, or executed remotely. For example, a portion of the entertainment platform 130 may be a local library or process, while another portion of the entertainment platform 130 may be an object bundled for processing at a local or remote client 105. In another example, the majority of processes or modules may reside—or processing take place—on the client 105. Moreover, the entertainment platform 130 may be a child or sub-module of another software module or enterprise application (not illustrated) without departing from the scope of this disclosure.

More specifically, in some instances the entertainment platform 130 may include a plurality of related portals that create an environment for members and users to interact in both social and business-related activities and interests. In some instances, the portals of the entertainment platform 130 may include, for example, an e-commerce micro-site portal, a multimedia directory portal, and a social network portal, among others. The e-commerce micro-site portal may provide members of the site (i.e., artists, songwriters, and record labels or distributors) with individualized pages for displaying, distributing, and marketing their artistic goods and services. For instance, some micro-sites may provide functionality for members to sell or freely distribute their own media, including recorded video (i.e., Windows Media File, etc.) or audio (i.e., MPEG Audio Layer 3 (MP3), Advanced Audio Coding (AAC), etc.) files.

The multimedia directory portal may be a commercial portal and/or professional social network providing members or users an opportunity for interactive exchange of marketing, merchandising, and viral marketing tools. In some instances, the multimedia directory portal may be defined into five (5) directory exchanges: an artist directory, a songwriter directory, a record label directory, an artist management directory, and a talent buyer directory. As previously described, members or users associated with the entertainment platform 130 may create customized industry profiles associated with one or more of the directory exchanges. In some instances, the profiles may include various sets of personal and business information and media, including, for instance, embedded video and audio files, graphics, photos and photo galleries, professional and personal biographies, geographical locations, personal and professional contact information (i.e., email, phone number, instant messaging, etc.). Industry profiles for members may vary in content according to the particular directory exchange in which membership is held. For instance, an industry profile for a member of the artist directory may include information on the genre of the artist's music or the artist's recording and live performance experience and media such as audio and video files of the artist's performances. An industry profile for a member of the songwriter directory may include information on the songwriter's previous work and collaborations, as well as media associated with portions of the songwriter's work. Industry profiles in the record label directory may provide information on the types of acts and music associated with a particular record label, including the type of artists already signed to the record label, as well as media associated with its artists, to promote the record label. Industry profiles in the artist management directory may include information on a manager's list of clients, experience, and other pertinent information. Finally, industry profiles in the talent buyer directory can include information on the types of talent and events sought, as well as information on the types of talent and entertainment that were previously purchased by the talent buyer. Further, entertainment platform 130 may provide functionality allowing members and users to search for other members or users within the same or different multimedia directories. For instance, members in the record label directory may be able to search for members of the artist directory for young or unknown artists that are not signed with a record label. By searching based on artist's biographical information, genre, and samples of the artist's work, record label representatives may be able to locate unsigned or unknown talent using the entertainment platform 130.

The social network portal of the entertainment portal 130 may be a music and music-related social network, providing an environment for artists, music fans, and consumers (as well as other members) to socially interact through industry and user profiles, instant messaging, chat, media, and other typical social networking functionality. The social network portal may allow members of the multimedia directory portal, non-member artists or performers, and individual fans or consumers to create user-generated profiles similar to those described with regard to the industry profiles of the multimedia directory. The social network portal, while offering a robust social network, may also integrate the business of music from an educational, profitable, and functional content perspective. The social network portal may offer functionally including user-generated video and audio, comments, photos, blogs, discussion groups, instant messaging, podcasts, online chat, guest books, friends, text and video email, invite features, and tagging, as well as interoperability with other social networking sties. The social network portal may promote and provide the technology for membership interactivity, entertainment, education, personal profitability, communication tools, and other social network functionality.

The illustrated entertainment platform 130 is also associated with the layered search and profiling module 135, which may be embedded within or included as part of the entertainment platform 130 as shown in FIG. 1, or instead, may be communicably coupled to the entertainment platform 130 within server 155. In still other instances, the layered search and profiling module 135 may be a separate application located remote from the server 155, yet tightly integrated with the entertainment platform 130 via one or more connections with the network 115. In those implementations, the layered search and profiling module 135 may provide the functionality disclosed in the present application—specifically, the module 135 may receive industry profile search criteria from one or more clients 105, query the plurality of industry profiles 145 and/or the set of cached search results 150, return the set of matching industry profiles 145 to the client 105, cache the set of search results generated by the search, and, in some instances, generate a visual interface at the client 105 for review of and interaction with the returned industry profiles.

Generally, the layered search and profiling module 135 provides functionality that allows members or users to cache data pools using a layer-by-layer demographic classification and search (or layered search), with each advancing pool becoming more specific to the member or user's defined criteria. The layered search function allows the member or user performing the search to evaluate industry profiles 145 in each advancing layer pool until the member or user finds the profile matching the criteria they are searching for, while the profiling functionality may automatically extrapolate industry profile data based upon the set of criteria submitted by the searching member or user. The layered search and profiling module 135 may allow members or users to design, by template, the exact profile and criteria associated with a desired industry profile. Using the profile template designed by the searching member or user, the layered search and profiling module 135 may automatically search the plurality of industry profiles 145 for profiles matching the set of profiling data, extrapolate the desired data for the plurality of industry profiles 145 for each industry profile matching the profile template, organize the data into a formal report, and transmit the formal report to the appropriate member or user. In some instances, the layered search and profiling module 135 may notify the searching member or user through the entertainment platform 130 with a message or other notification method that the formal report has been generated and is ready for review. In some instances, the formal report may be accessed and reviewed through the entertainment platform 130, while in other instances, the report may be received through channels outside of the platform 130, such as an email or other external method.

As described, the layered search and profiling module 135 (and/or the entertainment platform 130) may generate or supply a visual interface for an industry profile search template (or profile template) to the GUI 110 at one or more clients 105. Search parameters and criteria submitted by members or users at the one or more clients 105 using the industry profile search template may then be transmitted to the layered search and profiling module 135 (and/or the entertainment platform 130). If the information supplied represents an initial profile search (i.e., not a layered search), the layered search and profiling module 135 may query the plurality of industry profiles 145 for profiles matching the criteria submitted by the member or user. In instances where one or more industry profiles 145 are located or stored outside of the server 155, the query from the layered search and profiling module 135 may be transmitted across the network 115 to the appropriate set of data. In some instances, the layered search and profiling module 135 may include the programming necessary to communicate with memory 140 and the one or more clients 105, while in other instances, the layered search and profiling module 135 may be a portion of or rely on the programming and functionality of the entertainment platform 130 to communicate with other elements in the illustrated environment 100. Indeed, in certain implementations, the layered search and profiling module's 135 functionality may be limited to organizing industry profile search criteria and returned search results as they are transmitted between the entertainment platform 130 and one or more clients 105. In those implementations, the entertainment platform 130 may perform functions including receiving search criteria from the client 105, generating and presenting a visual interface to the one or more clients 105 for presenting industry profile search template and returned search results, and querying memory 140 (i.e., the plurality of industry profiles 145 or the set of cached search results 150) for industry profiles matching the received industry profile criteria, as well as other operations involved in the searching process. Thus, the layered search and profiling module 135 may be wholly, or in part, comprised of additional programming and/or instructions written into the internal code of the entertainment platform 130.

Further, the server 155 may include an interface 120 for communicating with other computer systems in a client-server or other distributed environment, such as clients 105 or other servers (not shown) connected to the network 115. Generally, interface 120 comprises logic encoded in software and/or hardware in a suitable combination and operable to communicate with the network 115. More specifically, interface 120 may comprise software supporting one or more communication protocols associated with communications such that the network 115 or hardware is operable to communicate physical signals.

The network 115 facilitates wireless or wireline communication between the server 155 and any other local or remote computer, such as one or more clients 105. Indeed, while illustrated as one network, the network 115 may be a discontinuous network without departing from the scope of this disclosure, so long as at least a portion of the network 115 may facilitate communications between senders and recipients. The network 115 may be all or a portion of an enterprise or secured network. In some instances, a portion of the network 115 may be a VPN merely between the server 155 and the client 105 across a wireline or wireless link. Such an example wireless link may be via 802.11a, 802.11b, 802.11g, 802.20, WiMax, or other types of wireless links. In other words, the network 115 encompasses any internal or external network, networks, sub-network, or combination thereof operable to facilitate communications between various computing components in the systems. The network 115 may communicate, for example, Internet Protocol (IP) packets, Frame Relay frames, Asynchronous Transfer Mode (ATM) cells, voice, video, data, and other suitable information between network addresses. The network 115 may include one or more local area networks (LANs), radio access networks (RANs), metropolitan area networks (MANs), wide area networks (WANs), all or a portion of the Internet, and/or any other communication system or systems at one or more locations. In certain implementations, the network 115 may be a secure network associated with the enterprise and certain local or remote clients 105.

The client 105 may be any computing device operable to connect or communicate with server 155 or the network 115 using a wireless or wireline connection. At a high level, each client 105 includes at least the GUI 110, and comprises an electronic computing device operable to receive, transmit, process, and/or store any appropriate data associated with the entertainment platform 130 and/or the layered search and profiling module 135. It will be understood that there may be any number of clients 105 communicably coupled to the server 155 at any one point in time. For example, the environment 100 may include two local clients 105 as illustrated in FIG. 1, as well as other clients external to the illustrated portion of the network 115 (not illustrated). Further, “the client 105,” “members,” and “user” may be used interchangeably as appropriate without departing from the scope of this disclosure. For example, the user may access a first instance of the entertainment platform 130 on a first client 105, while a member may use a second instance of the entertainment platform 130 on a second client 105. Moreover, for ease of illustration, each client 105 is described in terms of being used by one user. This disclosure, however, contemplates that more than one user may use one client 105, or that one user may use multiple clients 105. As used in this disclosure, the client 105 is intended to encompass a personal computer, touch screen terminal, workstation, network computer, kiosk, wireless data port, smart phone, personal data assistant (PDA), one or more processes within these or other devices, or any other suitable processing device. For example, the client 105 may comprise a computer that includes an input device, such as a keypad, touch screen, mouse, or other device that can accept information, and an output device that conveys information associated with the operation of the server 155 or the clients 105, including digital data, visual information, or the GUI 110. Both the input device and the output device may include fixed or removable storage media, such as a magnetic computer disk, CD-ROM, or other suitable media to both receive input from and provide output to users of the clients 105 through the display, namely, the GUI 110.

GUI 110 comprises a graphical user interface operable to allow the user of the client 105 to interface with at least a portion of environment 100 for any suitable purposes such as to allow the client 105 to interact with the entertainment platform 130 and layered search and profiling module 135, and to provide an interface for displaying, updating, and searching industry profile information associated with the entertainment platform 130. Generally, the GUI 110 provides the client 105 with an efficient and user-friendly presentation of data provided by or communicated within the system. In particular, the GUI 110 may provide members or users of the entertainment platform 130 with access to data stored within memory 140. The GUI 110 may comprise a plurality of user interface (UI) elements such as interactive fields, pull-down lists, and buttons operable at the client 105. These UI elements may be associated with industry profiles 145, as well as searching or profiling functionality provided by the layered search and profiling module 135 and the entertainment platform 130, such as searching for or reviewing a set of industry profiles 145 matching a certain set of criteria submitted by the member or user. In one implementation, the GUI 110 may provide a centralized and interactive display capable of presenting industry profile-related information retrieved from one or more of the plurality of industry profiles 145 and organized by the layered search and profiling module 135. In some instances, the GUI 110 may provide a view displaying a list of industry profiles 135 matching a first set of criteria as specified by a member or user. In other instances, the GUI 110 may provide an interactive industry profile search template including one or more search criteria associated with a subset of members or users of the entertainment platform 130. In still other implementations, the GUI 110 may provide a view displaying an interactive industry profile search template for performing a layered search of the industry profiles 145 associated with the first set of criteria. The display for the industry profile layered search template may provide indications of previously defined search criteria, as well as a template for providing an additional, narrowing set of layered search criteria to further limit the previously returned set of industry profiles 145. Moreover, it should be understood that the term graphical user interface may be used in the singular or in the plural to describe one or more graphical user interfaces and each of the displays of a particular graphical user interface. Therefore, the GUI 110 contemplates any graphical user interface, such as a generic web browser, touch screen, or command line interface (CLI) that processes information in environment 100 and efficiently presents results to the member or user. The server 155 can accept data from the clients 105 via the web browser (e.g., Microsoft Internet Explorer or Mozilla Firefox) and return the appropriate HTML or XML responses using the network 115.

Environment 100 may further include one or more external data sources 160 from which additional information associated with the plurality of industry profiles 145 may be derived. In some instances, the external data sources 160 may include or comprise one or more external social networks, one or more ecommerce or online music retailer websites or databases, a music or radio chart database or service, a member's or user's personal or professional website, as well as any other relevant sources. In some instances, the external data sources 160 may be manually linked or associated with a particular industry profile 145 by the associated member or user, while in other instances one or more of the external data sources 160 may be automatically associated with one or more of the plurality of industry profiles 145 based on the external data sources' 160 predefined relationships to the entertainment platform 130. Information derived from the external data sources 160 (or references thereto) may be stored in the set of external data 153 located in memory 140. The entertainment platform 130 and the layered search and profiling module 135 may communicate with the one or more external data sources 160 via the connections of network 115. The one or more external data sources 160 provide an additional source of information for the plurality of industry profiles 145 that allows the entertainment platform 130 to provide a single location for a comprehensive set of information on the member or user associated with the entertainment platform 130 that is searchable using the functionality of the entertainment platform 130.

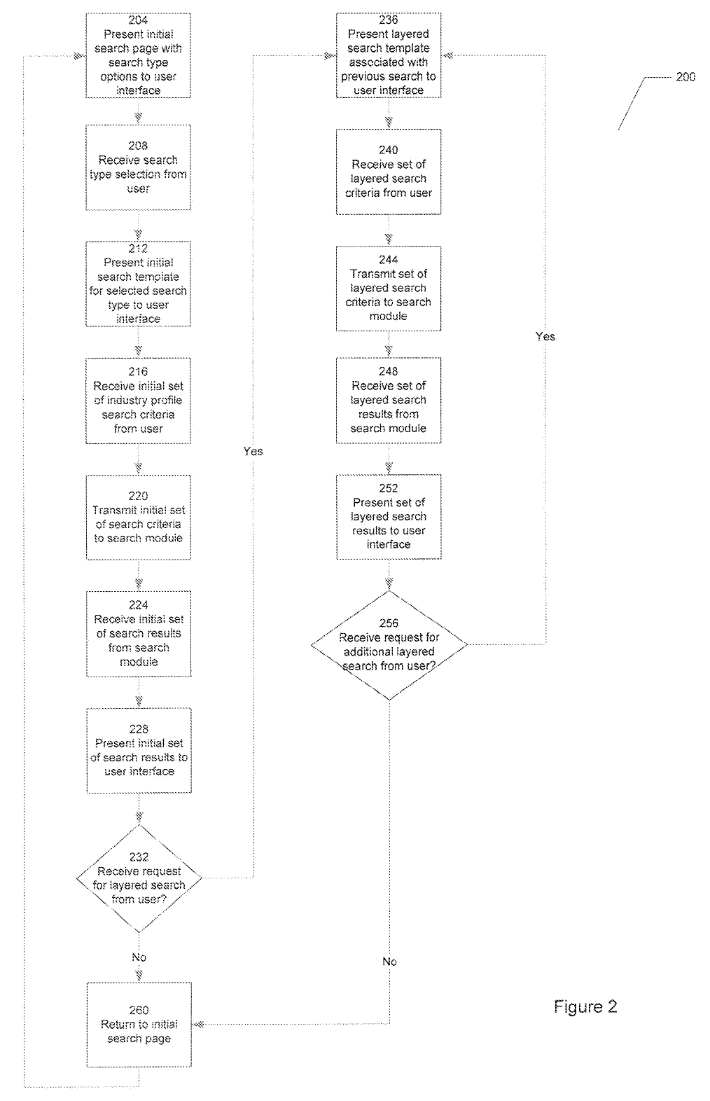

FIG. 2 provides a flowchart illustrating an example process 200 at client 105 for searching the plurality of industry profiles 145 related to one or more members or users. While this flowchart illustrates one particular embodiment of environment 100, this disclosure contemplates using any appropriate combination and arrangement of logical elements to implement some or all of the described functionality. At a high level, process 200 describes one particular implementation for facilitating the searching of the plurality of industry profiles 145 at the client 105.

At step 204, the GUI 110 of client 105 presents an initial search page with search type options to the member or user interacting with the client 105. Prior to or concurrently with step 204, the member or user may be interacting with other portions or functionality of the entertainment platform 130. In those instances, the initial search page may be a portion of the GUI 110 at client 105 displaying an interface associated with the entertainment platform 130. For example, the initial search page may be represented by a drop-down box associated with a navigational menu or a table embedded within a portion of the GUI 110. In other instances, the initial search page may take up the entire GUI 110 as a new page or window presented to the member or user.

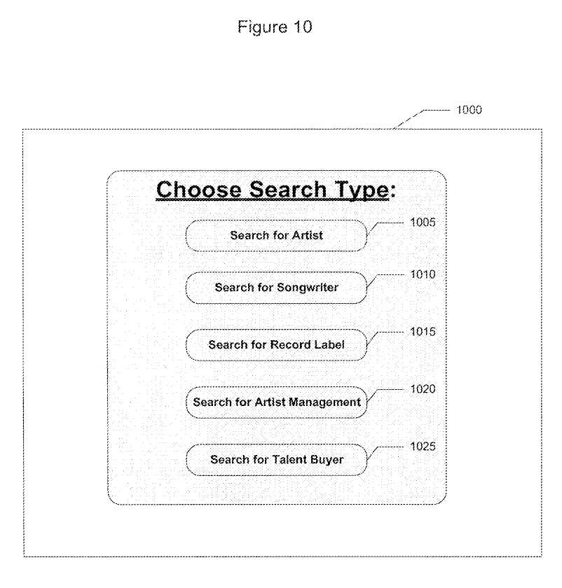

FIG. 10 illustrates one implementation of the initial industry profile search page 1000 for a particular embodiment of the environment 100 illustrated in FIG. 1. As shown in FIG. 10, the initial user search page 1000 may present a number of search options and types to the member or user accessing the entertainment platform 130. For instance, the illustrated initial industry profile search page 1000 provides five search options: an artist search 1005, a songwriter search 1010, a record label search 1015, an artist management search 1020, and a talent buyer search 1025. Alternative implementations may include a number of other search types including, but not limited to, radio broadcast searches, music composer searches, music publisher searches, record producer searches, recording engineer searches, studio musician searches, and music video producer and director searches. These searches represent at least a portion of the types or classifications of members or users associated with the entertainment platform 130. In many implementations, each member or user associated with a profile within the plurality of industry profiles 145 may be associated with a particular classification. In at least some of those implementations, each member or user may provide the information necessary to classify themselves when creating or updating their associated industry profile 145. In some instances, members and users may not be classified as a certain type of industry profile, while in other implementations, the plurality of industry profiles 145 may not include any classifications or divisions of members or users. In those implementations, process 200 may start at step 212. Returning to FIG. 2, the client 105 receives a selection from the member or user at step 208 of one or more of the industry profile search types provided in the initial industry profile search page 1000 of FIG. 10.

Once a particular industry profile search type has been selected, at step 212 the client 105 can present an initial industry profile search template associated with the selected industry profile search type at GUI 110. The initial industry profile search template associated with each classification of industry profiles may provide different sets of search criteria and information on which to base the search. For instance, when members or users choose an artist search, one of the search criteria listed may be the live performing experience of the artist. In many instances, it is unlikely that industry profiles 145 for record label representatives would include information on a record label representative's live performing experience. However, a record label representative's industry profile 145 may contain one or more data fields or information not included within an artist's industry profile 145. Thus, each initial industry profile search template may be designed in accordance with the basic constraints and information associated with the particular type of industry profile search being performed.

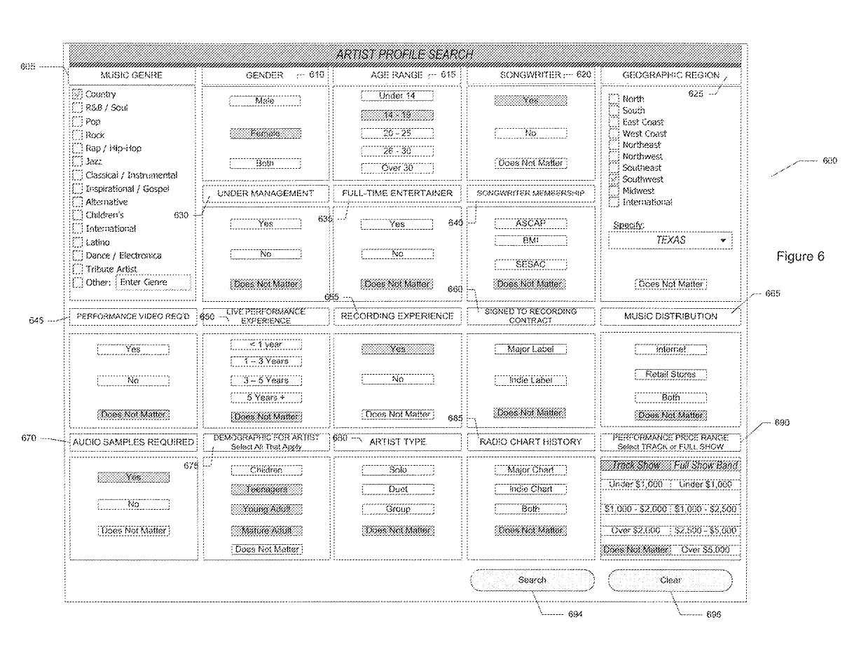

FIG. 6 illustrates an example initial industry profile search template interface 600 provided to the GUI 110 of client 105 at step 212. For the illustrated embodiment of FIG. 6, the initial industry profile search template interface 600 represents the interface provided to the GUI 110 after receiving a selection for the artist industry profile search 1005 at step 208. The interface 600 includes a plurality of search criteria which a member or user can define in order to search for one or more industry profiles 145 matching the defined criteria. In the present illustration, the initial industry profile search template interface 600 associated with an artist search includes the following search criteria: the artist's music genre 605, the artist's gender 610, the artist's age range 615, whether the artist is a songwriter 620, the artist's geographic region 625, whether the artist is under management 630, whether the artist is a full-time entertainer 635, whether the artist has a songwriter membership 640, whether matching industry profiles 145 should have video samples or performances of the artist 645, the artist's live performance experience 650, the artist's recording experience 655, whether the artist is signed to a recording contract 660, the type of music distribution for the artist 665, whether matching industry profiles 145 should have audio samples or performances of the artist 670, the demographics associated with fans of the artist 675, the artist's type 680 (e.g., solo, duet, or group), the artist's radio chart history 685, and the performance price range for either a track or full show of the artist 690. In some instances, one or more of the search criteria may allow for selection of multiple parameters for the search criteria. For example, the artist's music genre 605 of FIG. 6 may be selected for both the rock and country genres. Additional, alternative, or fewer search criteria may be included in other implementations.

Returning to FIG. 2, at step 216 the client 105 receives an initial set of industry profile search criteria from the member or user through GUI 110 in response to the initial search template provided at step 212. FIG. 6 shows the initial industry profile search template interface 600 after receiving the initial set of industry profile search criteria from the member or user. According to the initial set of industry profile search criteria selected in the search template interface 600, the industry profile search would return one or more industry profiles 145 having the following criteria—a female country artist and songwriter between the ages of 14-19 from the Southwest (specifically, Texas) with recording experience who is popular among the demographics of teenagers, young adults, and mature adults, and whose industry profile 145 includes audio samples of the artist's work. Once the member or user has specified the initial search criteria desired, the member or user may activate the search button 694. If the member or user has made an error in selecting the criteria or would like to restart, the member or user may activate the clear button 696 to return each search criteria to its default value. Once the search button 694 is activated, the client 105 receives the set of search criteria at step 216. In some alternative embodiments, the client 105 may automatically transmit each defined search criteria after each criteria's selection. In those embodiments, industry profile searches may be performed concurrently with ongoing selections of additional, layered search criteria. In those instances, the first criteria defined would be the initial set of industry profile search criteria described with regard to step 216, while each additional criteria defined would be a set of layered search criteria described below with regard to the present disclosure.

At step 220, the client 105 transmits the received initial set of search criteria to the layered search and profiling module 135. In some instances, such as the instance illustrated in FIG. 2, the client 105 may transmit the initial set of search criteria directly to the layered search and profiling module 135 via the network 115. In other instances, the client 105 may instead transmit the initial set of search criteria to the entertainment platform 130, relying on the entertainment platform's 130 functionality to supply the search criteria to the layered search and profiling module 135 or perform the search. Regardless of the destination of the information, the initial set of search criteria is transmitted to the layered search and profiling module 135 for further use.

After transmitting the initial set of search criteria, at step 224 the client 105 receives an initial set of search results from the layered search and profiling module 135. In some instances, the initial set of search results may include a single industry profile 145 from the plurality of industry profiles 145 that matches the initial set of search criteria submitted by the client 105. In other instances, several industry profiles 145 may be returned. In still other instances, a large set of industry profiles 145 may be returned in the initial set of search results, making a review of the industry profiles 145 time-consuming and unwieldy.

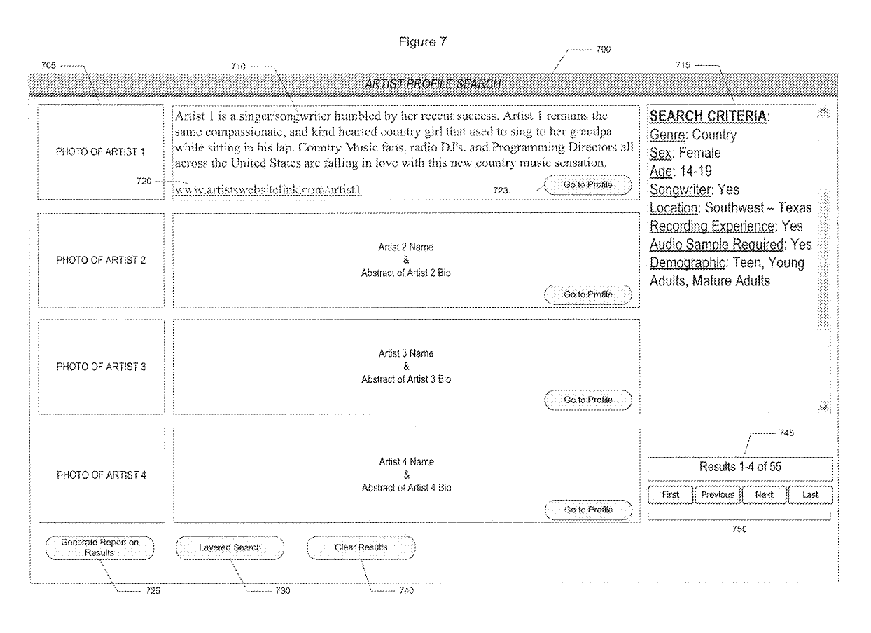

At step 228, the client 105 presents the initial set of search results to the GUI 110 for review and analysis by the member or user. FIG. 7 illustrates an example search results interface 700 presenting the initial set of search results at the GUI 110. In some instances, the search result interface 700 may be a new window or tab in the GUI 110, while in other instances the interface 700 may be a portion of the display within the GUI 110. The search results interface 700 may display a subset of the information stored within the industry profile 145 of each profile included within the initial set of search results. For instance, the example search results interface 700 illustrated in FIG. 7 provides a photo 705 of each artist (e.g., the main photo 905 of the generic industry profile 900), an abstract of the artist's industry profile 710 (e.g., all or a portion of the user biography 915 or personal and professional information 950 of the generic industry profile 900), and a link 720 to each artist's web page or profile (e.g., the user website link 920 of the generic industry profile 900). The link 720 may be designated as an external link to the artist's personal or professional web page, as well as an internal link to a web page or location within the entertainment platform 130 associated with the artist. In other implementations, additional, alternative, larger, or smaller sets of industry profile data may be included for each search result. Additionally, each result may include a link 723 to the full version of each associated industry profile 145. The search results interface 700 may include a listing of the current search criteria 715 for member or user review. The listing of search criteria 715 provides a clear description of the current search criteria used to return the one or more results listed in the search results interface 700. In some instances, the search results interface 700 may provide options for sorting the set of results so that members or users can prioritize the results based on any criteria (including both defined and undefined search criteria) associated with the one or more industry profiles 145 returned.

The search results interface 700 may include a generate report on results button 725. The generate report on results button 725 may be used to begin a process (not shown) for analyzing and/or organizing the current set of search results and presenting them to the user in a report format. In some instances, reports may automatically be generated whenever a search (either an initial search, layered search, or both) is performed, or at specific intervals or based on particular events. Generated reports may include detailed listings of each industry profile 145 returned by the search, as well as graphs and charts showing trends and values associated with the returned industry profiles 145. In some instances, the generated report may be generated by the layered search and profiling module 135 and automatically transmitted to the member or user through the network 115, such as through an email or instant message associated with the entertainment platform 130. In some instances, the generated report may be viewable within the GUI 110 as a portion of the entertainment platform 130 displayed. In other instances, the client 105 may perform the steps for generating the report. Each report may be generated in any appropriate format for review or use by the member or user, including, but not limited to, a Microsoft Word file, a Microsoft Excel file, a comma-delimited data file, or an XML file.

The search results interface 700 may also include a layered search button 730. The layered search button 730 allows the member or user to perform a more detailed search to the returned set of search results by adding new criteria to the industry profile search, thus further narrowing the already returned set of search. Still further, the search results interface 700 may also include a clear results button 740 allowing the member or user to remove the defined criteria in the current search. In some instances, activation of the clear results button 740 may cause the GUI 110 to return to the initial industry profile search template 600 or the initial search page 1000. Finally, GUI 110 may include a search results navigation area 745 providing the member or user with the amount of results returned, as well as buttons 750 (i.e., first, previous, next, and last buttons) for navigating through the returned set of search results.

Returning to FIG. 2, at step 232 the client 105 determines whether a request for a layered search from the member or user is received. In some instances, the request for the layered search may be received from the activation of the layered search button 730 described in FIG. 7. In others, each value defined for a new search criteria may act as a request for a layered search such that client 105 determines that a request for a layered search has been received. If a request for a layered search is received by the client 105, then process 200 continues at step 236. However, if no request for a layered search is received by the client 105, process 200 proceeds to step 260 where the client 105 may return the GUI 110 to the initial search page.

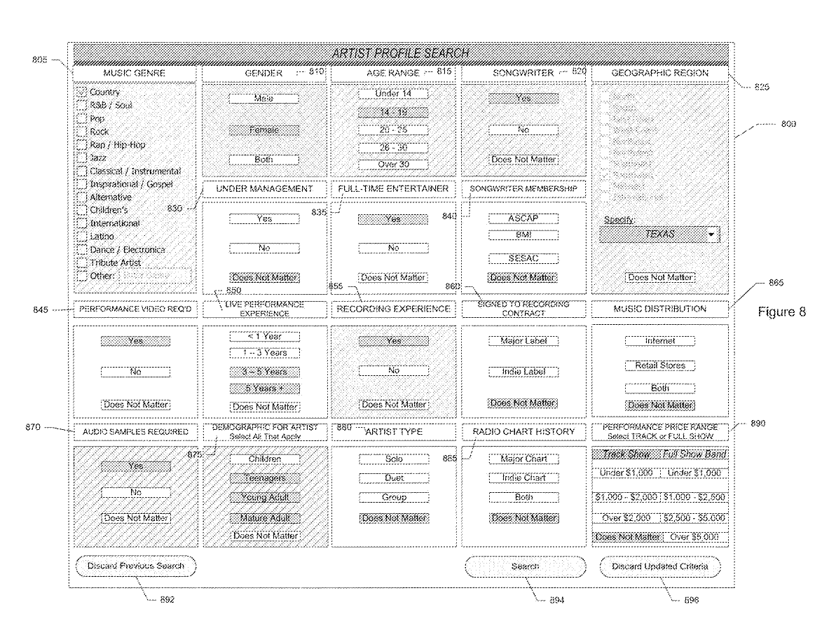

At step 236, the client 105 presents a layered industry profile search template associated with the previous search performed by the member or user. FIG. 8 illustrates one example of the layered search page template 800. In the illustrated example, the general layout mirrors that of the initial search page template 600 illustrated in FIG. 6. However, while the layered search page template 900 includes each of the search criteria of the initial search page template 600, the previously defined search criteria (as illustrated in FIG. 6, including the artist's music genre 605/805, the artist's gender 610/810, the artist's age range 615/815, whether the artist is a songwriter 620/820, the artist's geographic region 625/825, the artist's recording experience 655/855, whether matching industry profiles 145 require audio samples of the artist 670/870, and the demographics associated with fans of the artist 675/875) are unavailable for selection or modification in the layered search page template 800. Only the criteria that have not been defined (i.e., elements 830, 835, 840, 845, 850, 860, 865, 880, 885, and 890 of FIG. 8) remain possible search criteria for layered searches. Thus, the layered search page template 800 insures that the layered search performed will be based on a subset of the results returned from the previous search, and not a new search including industry profiles other than those returned from previous searches. In some instances, the previously defined search criteria may not be included or displayed in the layered search page template 800 to avoid member or user confusion and accidental modification.

Returning to FIG. 2, at step 240 the client 105 receives a set of layered search criteria from the member or user for a layered industry profile search. The example layered industry profile search template 800 of FIG. 8 shows the template 800 after receiving a set of layered search criteria in addition to the previously defined criteria of FIG. 6. According to the illustrated example, the layered industry profile search would return from the previous set of search results a set of industry profiles 145 matching the following set of layered criteria: a full-time artist with over 3 years of live performance experience whose industry profile 145 includes performance videos of the artist's work. Once the desired criteria has been selected, the member or user may activate the search button 894 to submit the new set of search criteria to the client 105. If the member or user has made an error during selection of the criteria, the discard updated criteria button 896 allows the layered industry profile search template 800 to be reset to its initial state, removing the new set of layered search criteria defined by the member or user, while retaining the search criteria defined in previous searches. The discard previous search button 892, on the other hand, allows members or users to discard the previous search results. In those instances, the GUI 110 may return to the initial industry profile search template 600, the initial industry profile search page 1000, or any other appropriate page, display, or interface.

Returning to FIG. 2, after the member or user submits the set of layered search criteria, the client 105 transmits the set of layered search criteria to the layered search and profiling module 135 for processing at step 244. In some instances, the same method used to transmit the initial set of industry profile search criteria to the layered search and profiling module 135 in step 220 may be used to transmit the set of layered search criteria in step 244. In other instances, alternative methods of transmitting the criteria may be used.

At step 248, the client 105 receives a set of layered search results from the layered search and profiling module 130. In some instances, depending on the number of industry profiles 145 returned in previous searches and the search criteria included within the current layered search, the set of layered search results may include a subset of the previously returned set or sets of search results. For instance, if the previous search returned 50 results, the set of layered search results may include fewer than 50 industry profiles 145. In some instances, the layered search criteria received at step 240 may be common to each of the industry profiles 145 returned in the previous search. In those instances, the set of layered search results would include the same number of industry profiles 145 as the previous search results. At step 252, the client 105 presents the set of layered search results to the GUI 110 for review and analysis by the member or user. In some implementations, the set of layered search results may be presented using the search results interface 700 of FIG. 7. The industry profile information included in the search results interface 700 can reflect the updated set of layered search results while the listing of search criteria 715 can include the additional criteria included in the layered search. As previously described, the search results interface 700 may provide a button 725 for generating reports on the set of layered search results. Additionally, the layered search button 730 may be activated to perform additional layered searching. The search results navigation area 745 may display the number of search results returned by the layered search. In some instances, the search results navigation area 745 (or another portion of the search results interface 700) may display a comparison of the current number of layered search results with the number of results from previous searches, allowing the member or user to identify the number of industry profiles 145 removed from the previous set of results after performing the layered search. This feature can allow users to easily understand and recognize the effect of adding new layered search criteria to the previously returned set of search results.

Returning to process 200 of FIG. 2, at step 256 the client 105 determines whether it receives a request for an additional layered search from the member or user. Similar to step 232, the request for an additional layered search may be received or signaled through the activation of the layered search button 730 within the search results interface 700, as well as other appropriate methods. If a request for an additional layered search is received, process 200 returns to step 236 and presents an updated layered search template 700. Additional layered searches may be performed until the member or user limits the set of search results to an acceptable and manageable number or until no additional search criteria remain to be defined. If a request for an additional layered search is not received by the client 105 at step 256, process 200 moves to step 260 where the client 105 may return the GUI 110 to the initial search page.

Once the member or user searching the plurality of industry profiles 145 locates one or more industry profiles 145 that match their interests or needs, the member or user may be able to contact the owner of the one or more matching industry profiles 145. In some instances, the inherent functionality of the social network portal and multimedia directory of the entertainment platform 130 can be used to communicate with or contact the owner of the matching profiles. For instance, instant messaging, email, and other communication methods or functionality of the entertainment platform 130 may be used to contact the member or user associated with a particular industry profile 145 included within the returned set of responsive industry profiles 145. Still further, some implementations may allow the searching member or user to interact with the one or more matching profiles, such as by booking or scheduling a performance, interview, or audition with the member or user associated with the particular profile 145, buying or viewing media included within or associated with the industry profile 145, as well as entering into or proposing a business relationship with the member or user associated with a particular industry profile 145. In other instances, the searching member or user may use a set of contact information included in each profile 145 to manually contact the industry profile's member or user.

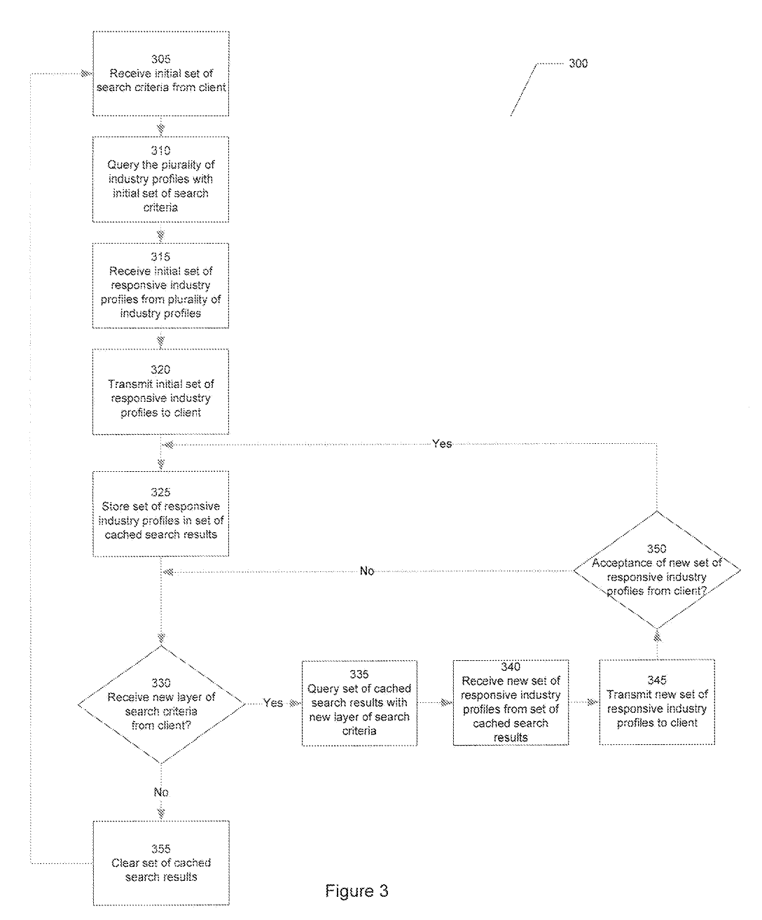

FIG. 3 provides a flowchart illustrating an example process 300 for searching the plurality of industry profiles 145 associated with the entertainment platform 130. In some instances, process 300 may be performed by the entertainment platform 130, the layered search and profile module 135, or a combination of the two elements. For example, the entertainment platform 130 may receive sets of criteria from client 105 and forward the set to the layered search and profiling module 135. The layered search and profiling module 135 may perform the actual queries and forward the results to the entertainment platform 130. The entertainment platform 130 may then transmit those results to the client 105 for review and further searching. In other implementations, however, alternative methods of implementing process 300 may be used. The example of the implementation described below uses the layered search and profiling module 135 to perform the steps of process 300.

At step 305, the layered search and profiling module 135 receives an initial set of search criteria for the client 105, the search criteria associated with an initial search of the plurality of industry profiles 145. The initial set of criteria may be received from the client 105 via the network 115. In some instances, the initial set of search criteria may include information limiting the search to a particular subset or classification of the plurality of industry profiles 145 (e.g., artists, songwriters, record labels, talent buyers, artist management, etc.). Generally, the initial set of criteria may represent a set of defined values for one or more data fields associated with at least a portion of the plurality of industry profiles 145. After receiving the initial set of search criteria, at step 310 the layered search and profiling module 135 queries the plurality of industry profiles 145 with the initial set of search criteria. If the plurality of industry profiles 145 are stored within or as a relational database, the search and profiling module 135 may access the plurality of industry profiles 145 using a query in a structured query language (SQL), which may include any of the plurality of versions of the SQL relational database query and manipulation language such as, for example, SEQUEL, ANSI SQL, any other proprietary or public variant of SQL, or other suitable or generic query language (such as eXtensible Markup Language (XML)). When the plurality of industry profiles 145 are not stored within or as a relational database, any appropriate query technology or technique may be used to search for and retrieve the industry profiles 145 matching the set of search criteria.

At step 315, the search and profiling module 130 receives an initial set of responsive industry profiles 145 from the plurality of industry profiles 145. The initial set of response industry profiles 145 is then transmitted via the network 115 to the client 105 for presentation to the GUI 110 at step 320. Additionally, at step 325 the layered search and profiling module 135 stores the set of responsive industry profiles in the set of cached search results 150. In some instances, the set of cached search results 150 may be stored separately from the plurality of industry profiles 145, including within a separate database of memory 140 or external to the server 155. In other instances, however, the set of cached search results 150 may be stored with or within the plurality of industry profiles 145, such as a separate table or list within the database storing the plurality of industry profiles 145. By storing or caching the set of responsive industry profiles, additional layer-by-layer searches, designed to narrow the set of responsive industry profiles, can quickly and efficiently access a (generally) smaller set of industry profiles than the set associated with the plurality of industry profiles 145. Because layered searches build upon previously-defined search criteria, the industry profiles 145 that are not included in prior sets of search results are irrelevant to the layered search and will not be responsive to further layers of search criteria. By limiting the layered search to the set of cached search results 150, processing time can be minimized while efficiency is increased. For instance, if the plurality of industry profiles 145 includes 10,000 industry profiles, an initial search may return a set of 100 industry profiles matching the initial search criteria. A layered search, adding criteria to the previously-defined search, allows the layered search and profiling module 135 to query or access only the smaller set of 100 industry profiles, ignoring the 9,900 other profiles that failed to meet the earlier set of search criteria.

At step 330, the search and profiling module 135 determines whether a new layer of search criteria associated with the previously returned set of responsive industry profiles 145 is received from the client 105. If the search and profiling module 135 does not receive a new layer of search criteria at step 330, process 300 continues at step 355 where the search and profiling module 135 may clear, delete, or overwrite the set of cached search results 150. For instance, if several layers of searching were previously performed, the results of those searches may be cleared once a new initial set of search criteria associated with a new search are received. In some instances, however, the set of cached search criteria 150, or at least a portion thereof, may be retained, either permanently or temporarily, so that members or users may return to previous searches and returned sets of responsive industry profiles in order to perform additional or continued layered searches on those previous sets of results. Retaining sets of responsive industry profiles may be advantageous when previous searches are later determined as too broad and need to be refined further refined at a later time. If, however, a new set of search criteria associated with a layered search are received from the client 105, process 300 continues at step 335.

At step 335, the search and profiling module 135 queries the set of cached search results 150 for previously-returned industry profiles that match the new layer of criteria. Similar to step 310, the type of query directed to the set of cached search results 150 is dependent upon how the set of cached search results 150 is stored. In some instances, the set of cached search results 150 may be stored in the same manner (or location) as the plurality of industry profiles 145, such that analogous queries can be used in both searches. In other instances, however, the set of cached search results 150 may be stored differently than the plurality of search results 145, and an alternative method of querying the set of cached search results 150 should be used. In either instance, the search and profiling module 135 receives a new set of responsive industry profiles from the set of cached search results 150 at step 340. In most instances, the new set of responsive industry profiles comprises a portion of the profiles contained within the set of cached search results 150 queried in step 335. In some instances, however, the new set of responsive industry profiles may be identical to the set of cached search results 150 queried in step 335 if the additional criteria supplied fail to distinguish between the cached set of industry profiles. However, in no instance will a layered search query result in a larger set of responsive industry profiles as compared to the previously returned set of responsive industry profiles stored in the set of cached search results 150.

After receiving the new set of responsive industry profiles, process 300 continues at step 345 where the new set of responsive industry profiles is transmitted or returned to the client 105. At step 350, the layered search and profiling module 135 determines whether the new set of responsive industry profiles is accepted by the client 105. In some instances, the new set of industry profiles returned by the layered search may provide either too narrow or too broad of a result set. In other instances, the layer of search criteria added may be inappropriate for the type of profile desired by the client 105. If the new set of responsive industry profiles is accepted by the client 105 at step 350, then the layered search and profiling module 135 can store the results in the set of cached search results 150 at step 325. As previously described, the new set of responsive profiles being stored may overwrite the previously returned sets of responsive industry profiles in the set of cached search results 150, while in other instances, the set may be stored concurrently with the previously returned sets of responsive profiles. If, however, the layered search and profiling module 135 determines at step 350 that the new set of responsive industry profiles is rejected by the client 105, then process 300 returns to step 330 without storing the new set of responsive industry profiles in the set of cached search results. Thus, the rejected results and search criteria may be cleared from the system, leaving the set of cached search results 150 unchanged from any prior searches. New layers of search criteria received at step 330 will be used to query the cached search results 150, ignoring the rejected set of responsive industry profiles and associated search criteria. Therefore, as layered searches continue to be received, only the immediately previous set of accepted responsive industry profiles will be queried at step 335. Layered searches may continue either until the member or user receives a satisfactory set of responsive industry profiles or until no additional search criteria remain to be defined.

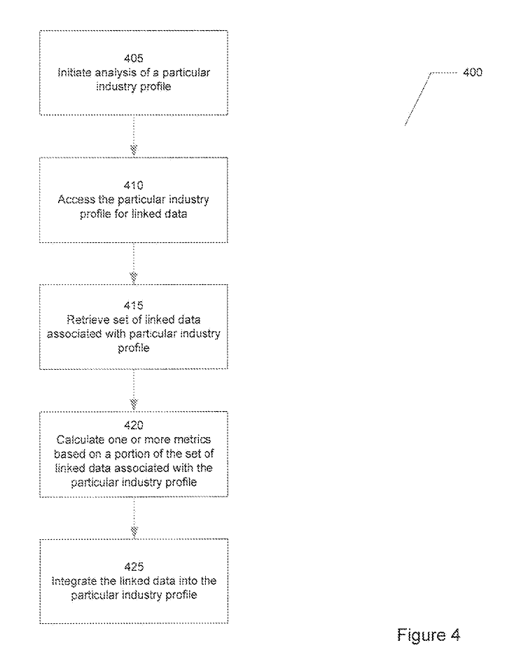

FIG. 4 provides a flowchart illustrating example process 400 for integrating linked or external data associated with a particular industry profile 145 into the particular industry profile 145. In the example of an industry profile associated with an artist, one or more other members or users may link their profile to the artist's industry profile 145 to signify or represent their status as a fan or friend of the artist represented by the particular industry profile 145. In other instances, certain other profiles for members or users may be linked to the particular industry profile 145 based on a previous purchase or rating of the artist's work. In another example, particular ones of the plurality of industry profiles 145 may be linked or associated with one or more external data sources 160, including external social networks, e-commerce sites or applications, industry charts or databases, as well as other types of external data. Process 400 allows the entertainment platform 130 and/or the layered search and profiling module 135 to retrieve some or all of the additional data, calculate one or more metrics associated with a portion of the additional and external data, and integrate some or all of the linked or associated information, data, and metrics into the particular industry profile 145. By integrating this additional and external information, data, and metrics, additional sets of relevant and searchable information can be added to the particular industry profile 145 to increase the set of searchable industry profile criteria associated with the plurality of industry profiles 145. In the particular implementation of FIG. 4, the layered search and profiling module 135 performs the steps of process 400, although alternative implementations may use either the entertainment platform 130 or a combination of the entertainment platform 130 and layered search module 135 to perform process 400.

At step 405, an analysis of the particular industry profile 145 is initiated. In some instances, the analysis may be automatically initiated by the layered search and profiling module 135 in response to a time- or event-based occurrence. In other instances, the process 400 may be manually initiated by a user at client 105. In the present example, the process 400 is initiated when some type of additional information or external data is associated with or linked to a particular industry profile 145. In other instances, process 400 may be initiated by any other appropriate trigger or action.

At step 410, the layered search and profiling module 135 accesses the particular industry profile 145 to retrieve information on linked or associated data related to the particular industry profile 145. For instance, the layered search and profiling module 135 may access information related to the plurality of associations with other members' or users' industry profiles 145 stored or referenced within the particular industry profile 145. The layered search and profiling module 135 may also retrieve various links to external data sources 160 from the particular industry profile 145. Using that information, at step 415 the layered search and profiling module 135 retrieves the set of linked or associated information from each of the locations (both external and internal) retrieved in step 410. For instance, if the particular industry profile 145 is linked to one or more other industry profiles of other members or users of the entertainment platform 130, then those associated industry profiles may be retrieved and accessed or queried for relevant data and information, such as the demographic and personal information associated with those associated profiles. If the particular industry profile 145 is linked or associated with one or more external data sources 160, then the layered search and profiling module 135 may use network 115 to communicate with and access the information stored within or by the external data sources 160. For instance, sales figures and information from an industry database or user profiles and fan information from other social networks, among others, may be retrieved. Collecting the data and information associated with these various links and external data sources 160 allows members and users of the entertainment platform 130 to take advantage of the investment and work put into the creation of external profiles on other social networks and other external information stored by the member or user or third parties. In other implementations, process 400 may instead search for and retrieve information associated with a particular industry profile 145 from common or industry recognized or accepted external data sources without explicit links or associations with the particular industry profile 145. For example, process 400 may access a commonly used set of external industry sales figures, search for any relevant information or data associated with the particular industry profile 145, and, if it does, retrieve the data. In order to retrieve the external data and information, the layered search and profiling module 135 (or the entertainment platform 130) can perform the appropriate processing necessary to retrieve the relevant information. For instance, the layered search and profiling module 135 may navigate a web browser to an external user profile, vendor, or website, wherein the module 135 may retrieve the information by reading a set of meta data associated with the external information, performing optical character recognition on the external information, using third-party modules, processes, or queries to access the one or more external data sources 160, as well as any other appropriate data retrieval method. Once the internal and external linked data and information has been retrieved, it may be stored (or referenced to) within the set of external data 153 of memory 140.

At step 420, the layered search and profiling module 135 may calculate one or more metrics for the particular industry profile 145 based on a portion of the retrieved set of information and data extracted from the linked and associated data. In some instances, the set of calculated metrics may include a set of information related to the gender, age range, or geographic distribution of the set of associated or linked industry profiles 145 of other members or users of the entertainment platform 130. In another instance, information and data on sales and market penetration associated with the industry profile 145 can be calculated from sales data retrieved in step 415. In some instances, the information and data may be retrieved in a format which does not need to or cannot be used as a metric. In those instances, step 420 may be skipped. At step 425, the layered search and profiling module 135 integrates the retrieved sets of information and data, as well as any metrics calculated from the retrieved information and data, into the particular industry profile 145. The integration may be accomplished using an appropriate query that adds or updates the information within the particular industry profiles 145. Using this technique, information related to and further describing the particular industry profile 145 may be added to enhance and complete the profile. Thus, members or users searching for a specific type of industry profile 145 may be provided with additional sets of criteria upon which to search for the target matching profile.

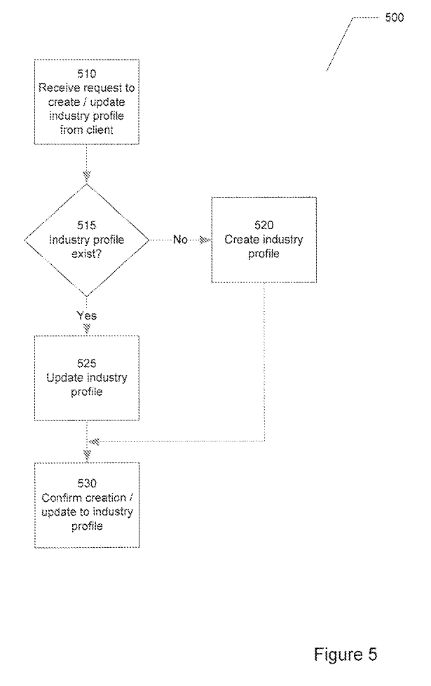

FIG. 5 provides a flowchart illustrating example process 500 for creating and updating an industry profile 145 (e.g., the generic industry profile 1000 of FIG. 10) associated with the entertainment platform 130. At step 510, the entertainment platform 130 receives a request to create or update a particular industry profile 145, either from the client 105 or from the layered search and profiling module 135 as in step 420 of FIG. 4. In some instances, the request may include a set of industry profile data and information to be associated with the particular industry profile 145. For example, if the request is associated with an artist, the creation or update request may include the artist's name, gender, age, genre of music, geographic location, professional information, and experience.

After receiving the request, at step 515 the entertainment platform 130 determines whether the industry profile 145 associated with the request of step 510 already exists or needs to be created. To determine whether the industry profile 145 exists, the entertainment platform 130 can access the plurality of industry profiles 145 through one or more queries using all or a subset of the criteria identified in the create or update request of step 510. If the entertainment platform 130 determines that an industry profile 145 associated with the request exists, then process 500 continues at step 525. If, however, the entertainment platform 130 determines that the requested industry profile 145 does not exist, then at step 520 the entertainment platform 130 creates a new industry profile 145 associated with the request. Once the industry profile 145 is created, process 500 continues at step 530. If the industry profile 145 does exist, then at step 525 the entertainment platform 130 updates the appropriate profile 145 with the information included with the request of step 510. In some instances, the entertainment platform 130 may update the user profile information by sending an appropriate SQL command to the relational database storing the plurality of user profiles 145. In other instances, the entertainment platform 130 may access the specific user profile 145 being updated and overwrite or insert the information directly into the user profile 145.

At step 530, the entertainment platform 130 confirms the creation of or update to the industry profile 145. In some instances, confirmation may comprise transmitting the set of industry profile information via network 115 to the client 105 for review and analysis at GUI 110 by a member or user. In other instances, confirmation may comprise a validity check on the created or updated industry profile 145. The validity check may include an analysis of the industry profile 145 to determine whether the data and information submitted satisfies the field restrictions and/or formatting requirements of the database fields associated with the plurality of industry profiles 145. For instance, an age data field within the industry profile 145 may be limited to numeric data. If the information received with the request of step 510 for the age data field is an alpha value, the information associated with the industry profile 145 may be invalid. In those situations, the entertainment platform 130 may transmit acknowledgement of the failure to update the industry profile 145 as requested to the client 105, and, in some instances, reject some or all of the update to the industry profile 145. Once the industry profile 145 is created and/or updated, the entertainment platform 130 may return to step 510 when a new creation or update request is received.

While the preceding flowcharts and accompanying descriptions illustrate exemplary processes 200, 300, 400, 500, and 600, environment 100 contemplates using or implementing any suitable technique for performing these and other tasks. It will be understood that these processes are for illustration purposes only and that the described or similar techniques may be performed at any appropriate time, including concurrently, individually, or in combination. In addition, many of the steps within each flowchart may take place simultaneously and/or in a different order than as shown. Moreover, environment 100 may use processes with additional steps, fewer steps, and/or different steps, so long as the process remains appropriate.

Although this disclosure has been described in terms of certain implementations and generally associated processes, alterations and permutations of these implementations and processes will be apparent to those skilled in the art. Accordingly, the above description of example implementations does not define nor constrain the present disclosure. For instance, alternative implementations of the present disclosure may apply the functionality described with regard to the layered search and profiling module 135 to other types of any other social network or directory associated with a plurality of user profiles. Additionally, while described in terms of the music industry, alternative implementations may include entertainment platforms for the movie or theater industries, as well as any other appropriate profession or industry. Other changes, substitutions, and alterations may be included within the scope of the claims included herewith.

What is claimed is:

1. Software for locating one or more industry profiles associated with an entertainment platform, each industry profile representing a member of an entertainment platform community, the software comprising computer readable instructions embedded on media and operable when executed to:
query a plurality of industry profiles with a first set of industry profile search criteria, wherein the first set of industry profile search criteria represents one or more criteria associated with a target member of the entertainment platform community;
generate a first cache of industry profiles based on the first set of industry profile search criteria, wherein the first cache of industry profiles is a subset of the plurality of industry profiles corresponding with the first set of industry profile search criteria;
query the first cache of industry profiles with a second set of industry profile search criteria, wherein the second set of industry profile search criteria represents one or more criteria associated with the target member of the entertainment platform community, the second set of industry profile search criteria mutually exclusive from the first set of industry profile search criteria;
generate a second cache of industry profiles based on the second set of industry profile search criteria, wherein the second cache of industry profiles is a subset of the first cache of industry profiles corresponding with the second set of industry profile search criteria; and
present information from at least one industry profile represented in the second cache to an interface.

2. The software of claim 1 further operable to extrapolate a set of data associated with the at least one industry profile for presentation to the interface.

3. The software of claim 2 further operable to generate a formal report including the extrapolated set of data associated with the at least one industry profile.

4. The software of claim 3, further operable to notify a client of the formal report generation.

5. The software of claim 3, wherein the formal report is generated in response to request from the client.

6. The software of claim 1, wherein the first and second sets of industry profile search criteria are received from the client through an industry profile search template.

7. The software of claim 1, wherein the second cache of industry profiles replaces the first cache of industry profiles in memory.

8. The software of claim 1, wherein the plurality of industry profiles are stored in a first storage location and the first and second caches of industry profiles are stored in a second storage location separate from the first storage location.

9. The software of claim 1 further operable to:
query the first cache of industry profiles with a third set of industry profile search criteria, wherein the third set of industry profile criteria represents one or more criteria associated with the target member of the entertainment platform community, the third set of industry profile search criteria mutually exclusive from the first set of industry profile search criteria and different from the second set of industry profile search criteria; and
generate a third cache of industry profiles based on the third set of industry profile search criteria, wherein the third cache of industry profiles is a subset of the first cache of industry profiles corresponding with the third set of industry profile search criteria and replaces the second cache of industry profiles in memory.

10. The software of claim 1, wherein the first set of search criteria comprises multiple parameters associated with the plurality of industry profiles.

11. The software of claim 10, wherein the multiple parameters comprising the first set of search criteria include more than one parameter for at least one industry profile search criteria.

12. The software of claim 1, wherein the set of data associated with each one of the plurality of industry profiles comprises one or more of the following:
data entered by the member of the entertainment platform community associated with the particular industry profile;
data from one or more industry profiles within the entertainment platform associated with other industry profiles, each of the one or more industry profiles associated with the particular industry profile; and
data from one or more sources external to the entertainment platform, each of the one or more industry profiles associated with the particular industry profile.

13. The software of claim 12, wherein the data from one or more sources external to the entertainment platform comprises data from one or more external social networking sites associated with the particular industry profile.

14. The software of claim 1, wherein the first and second sets of industry profile search criteria are provided by a member of the entertainment platform community.

15. The software of claim 14 further operable to automatically match the member of the entertainment platform community providing the first and second sets of industry profile search criteria with one or more members of the entertainment platform community associated with at least one of the industry profiles within the second cache of industry profiles.

16. The software of claim 15 further operable to facilitate contact between the member of the entertainment platform community providing the first and second sets of industry profile search criteria and at least one member of the entertainment platform community associated with at least one of the industry profiles within the second cache of industry profiles.

17. The software of claim 16, wherein the facilitated contact between the member of the entertainment platform community providing the first and second sets of industry profile search criteria and at least one member of the entertainment platform community comprises an attempt to enter a business relationship.

18. The software of claim 17, wherein the business relationship comprises a request to purchase media associated with the at least one member of the entertainment platform community.

19. The software of claim 17, wherein the business relationship comprises a request to book the at least one member of the entertainment platform community for one or more events.

20. The software of claim 17, wherein the business relationship comprises an attempt to sign the at least one member of the entertainment platform community to a recording contract.

21. The software of claim 1, wherein the plurality of industry profiles comprise industry profiles associated with musical artists.

22. A system comprising:
memory storing a social network module comprising a plurality of user profiles, each user profile representing a member of the social network user community, and a search module for locating one or more user profiles within the plurality of user profiles; and
one or more processors operable to:
query the plurality of user profiles with a first set of user profile search criteria, wherein the first set of user profile search criteria represents one or more criteria associated with a target member of the social network user community;
generate a first cache of user profiles based on the first set of user profile search criteria, wherein the first cache of user profiles is a subset of the plurality of user profiles corresponding with the first set of user profile search criteria;
query the first cache of user profiles with a second set of user profile search criteria, wherein the second set of user profile search criteria represents one or more criteria associated with the target member of the social network user community, the second set of industry profile search criteria mutually exclusive from the first set of user profile search criteria;
generate a second cache of user profiles based on the second set of user profile search criteria, wherein the second cache of user profiles is a subset of the first cache of user profiles corresponding with the second set of user profile search criteria; and
present information from at least one user profile represented in the second cache to an interface.

23. The system of claim 22, the one or more processors further operable to extrapolate a set of data associated with the at least one user profile for presentation to the interface.

24. The system of claim 22, wherein the first and second sets of user profile search criteria are received from the client through an user profile search template.

25. The system of claim 22, the one or more processors further operable to:
query the first cache of user profiles with a third set of user profile search criteria, wherein the third set of user profile criteria represents one or more criteria associated with the target member of the social network community, the third set of user profile search criteria mutually exclusive from the first set of user profile search criteria and different from the second set of user profile search criteria; and
generate a third cache of user profiles based on the third set of user profile search criteria, wherein the third cache of user profiles is a subset of the first cache of user profiles corresponding with the third set of user profile search criteria and replaces the second cache of user profiles in memory.
